(19) United States
(12) Patent Application Publication
(10) Pub. No.: US 2011/0266073 A1
(43) Pub. Date: Nov. 3, 2011

(54) MODULAR WEIGHBRIDGE

(75) Inventor: Georges Evesque, Meyzieu (FR)

(73) Assignee: ARPEGE MASTER K, CHASSIEU (FR)

(21) Appl. No.: 12/681,032

(22) PCT Filed: Oct. 1, 2007
(86) PCT No.: PCT/FR07/01600

§ 371 Date: May 4, 2010

(51) Int. Cl. G01G 19/02

(52) U.S. Cl. 177/133

(57) ABSTRACT

The invention relates to a member (1) for a weighbridge or a weighbridge module (20), particularly intended for weighing automobiles or wagons, that comprises an elongated bearing for forming a side portion of the upper surface of the bridge on which bear one or more wheels of the vehicle or wagon during the passage thereof on the bridge, at least two sensors positioned so as to be aligned in the longitudinal direction of the bearing and attached under the bearing, securing means (17, 19, 26) for attaching the weighing member (1) with another weighing member (1) of the same type via struts (22, 24), and a means for restraining the weighing sensors during the transportation of the member (1). The invention also relates to a weighbridge or weighbridge member (20) particularly intended for weighing automobiles or wagons and including two members (1) according to one of the preceding claims, and rigid linking means (22, 24) attached between the weighing members (1).

### TECHNICAL FIELD

The invention relates to an element for a weighbridge or to a weighbridge module, and to a weighbridge or to a weighbridge module comprising such an element.

The present invention relates in particular to elements and weighbridges or modules intended for weighing automotive vehicles or rolling stock. However, it may also apply to elements and weighbridges of smaller or larger size.

### BACKGROUND

Weighbridges of known type generally comprise a framework made up of metal frame members of the side rail and crossmember type, this framework being clad with metal plates and/or concrete slabs.

The framework is connected to elements for the attachment of one or more weighing sensors, a first part of each sensor being intended to be attached to the framework attachment element, and a second part being intended to rest against the weighbridge support.

The weighbridge support may consist, for example, of a cast concrete structure resting on the ground or in a trench dug in the ground.

There are also in existence transportable weighbridges which are not installed on a structure dedicated to this use but are simply placed on the ground.

Document FR 2 792 407 discloses support devices or joists intended to be set into the structure, when the latter is being created on the installation site, and which constitute known characteristic support means on which the mounting plates of a sensor can rest.

It is thus possible for a statically determinate weighbridge to be calibrated and primitively checked at the factory, and for the weighbridge then to be transported to the installation site, by immobilizing the two parts of the sensor relative to the structure of the weighbridge when the latter is being transported.

Primitive checks constitute a legislative requirement.

This solution means there is no longer any need for the sensors to be removed and refitted, and may significantly simplify installation, because there is no longer any need to test the weighbridge on the installation site.

In particular, there is no longer any need for calibration weights to be transported to the installation site in order to test the weighbridge.

However, it appears that weighbridges of this type do have to be transported as a single unit between the factory and the site at which the weighbridge is to be installed, in order to ensure that the tests carried out on the weighbridge at the factory will remain valid on the installation site. For a weighbridge of significant size, this transportation operation is complicated.

To alleviate these disadvantages, document EP 1 722 205 discloses the use of a modular weighbridge structure comprising statically determinate weighing modules comprising four sensors and modules for connecting the weighing modules.

These arrangements allow the weighing modules to undergo calibration and primitive checking at the site of manufacture, given that these weighing modules are statically determinate, before they are delivered to the installation site, allow these modules to be supplied to the installation site, and then allow connecting modules that do not have any weighing sensors or any direct connection to the weighbridge support to be positioned between these weighing modules without the need to test the end structure.

Even though this modular structure is based on elements of small size and low mass, particularly by comparison with a so-called monoblock weighbridge, it would, however, still appear that the size and the mass of the modules require the use of special purpose transport facilities.

### BRIEF SUMMARY

The invention seeks to address this disadvantage by proposing an element for a weighbridge or a weighbridge module that allows the use of conventional means of transport.

To this end, for that, the invention provides an element for a weighbridge or a weighbridge module, intended in particular for weighing automotive vehicles or rolling stock, comprising an elongate support intended to form a lateral part of the upper surface of the weighbridge on which one or more wheel(s) of the vehicle or of the rolling stock rests (rest) as the vehicle or rolling stock crosses the weighbridge, at least two sensors positioned aligned in the longitudinal direction of the support and attached under the support, means of attachment intended to attach the weighing element to another weighing element of the same type, means of lashing down the weighing sensors when the element is being transported.

These arrangements allow the weighbridge elements to be transported in the form of assemblies the width of which is less than that of the weighbridge, while at the same time maintaining the benefit of the calibration of the weighbridge. Specifically, each element comprising at least two sensors is intended to support the weight of one set of right or left wheels of a vehicle, and may be considered to be a stable assembly that can be calibrated prior to transport, the benefit of calibration being maintained through the lashing during transport.

Advantageously, the attachment means are designed to attach means of rigid connection between the elements.

This feature makes it possible to provide a mode of attachment that offers quick and easy assembly and dismantling of two elements.

For preference, the support comprises at least one part that forms formwork for casting concrete.

According to one feature of the invention, the support comprises at least two longitudinal side rails connected laterally by a plurality of transverse crossmembers.

Advantageously, the sensors are housed in a housing formed between two crossmembers.

For preference, at least one formwork-forming part is laterally delimited by the two side rails and longitudinally delimited by two end crossmembers, the bottom of the formwork including interjoists held in place by intermediate crossmembers shorter in height than the end crossmembers.

Advantageously, the formwork-forming part comprises a reinforcement of metal rods resting on the side rails and/or the end crossmembers.

According to one embodiment, the upper part of the sensor bears against a plate that bears against horizontal flanges of two crossmembers delimiting the housing.

Advantageously, the lashing-down means comprise means of screwing a mounting plate that constitutes the bottom part of the sensor to part of the support.

According to one feature of the invention, the screwing means are screwed to at least one crossmember delimiting the housing of the sensor.

The invention also relates to a weighbridge or weighbridge module, intended in particular for weighing automotive vehicles or rolling stock, comprising two elements according to the invention and means of rigid connection attached between the weighing elements.

### BRIEF DESCRIPTION OF THE DRAWINGS

The invention will be better understood with the aid of the detailed description set out hereinbelow with reference to the attached drawing in which:

FIG. 1 is a perspective view of an element for a weighbridge or a weighbridge module according to the invention;

FIG. 2 is a schematic depiction of a weighbridge comprising two elements according to the invention and a set of spacer pieces positioned between the two elements;

FIG. 3 is a schematic depiction of a weighbridge comprising four elements and a set of spacer pieces and of metal cover plates covering the central passage.

### DETAILED DESCRIPTION

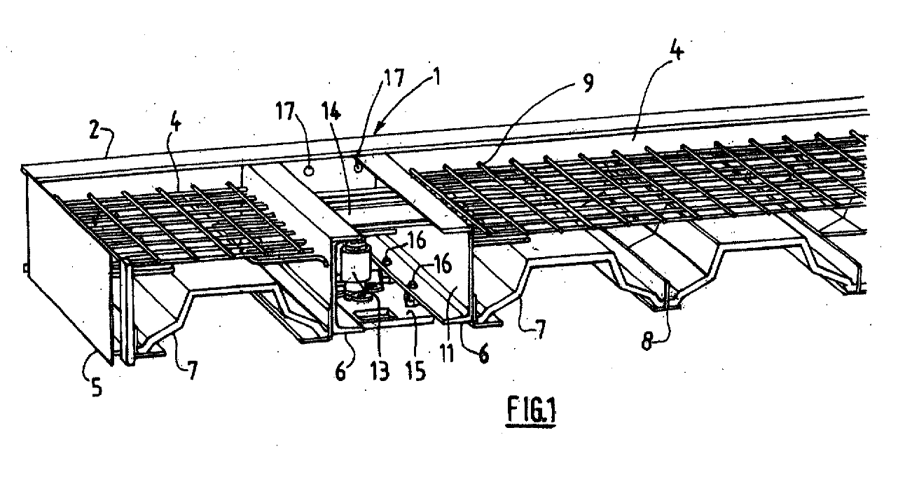

As depicted in FIG. 1, an element 1 comprises an elongate support. The elongate support comprises two parallel lateral side rails 2 made, for example, of steel. It should be noted that just one side rail 2 has been depicted in FIG. 1. Each side rail 2 has a substantially H-shaped cross section having a vertical wall and horizontal flanges meeting the vertical wall at its upper and lower ends.

The elongate support further comprises a set of transverse crossmembers positioned between the side rails 2.

The support comprises three formwork-forming parts 4 delimited laterally by the side rails 2, longitudinally by end crossmembers 5, 6, and the bottom of which is formed by interjoists 7 resting on intermediate crossmembers 8 shorter in height than the end crossmembers 5, 6.

Reinforcements 9 resting on the side rails 2 and/or on the end crossmembers 5, 6 are positioned near the interjoists 7. More specifically, they are situated above the interjoists 7.

Such formwork 4 is intended for casting concrete in order to obtain reinforced concrete.

To make the elements 1 easier to transport, they are transported without the concrete, the concrete being poured into the formwork-forming parts 4 on the site on which the weighbridge is to be installed or mounted. The use of reinforced concrete is essentially aimed at resisting and reacting tensile stresses, experienced particularly when a vehicle is being weighed and which could endanger the durability of the structure.

The support comprises two housings 11, positioned between two formwork-forming parts 4 and delimited laterally by the side rails 2 and longitudinally by two end crossmembers 6 of the two adjacent formworks.

As illustrated in FIG. 1, the crossmembers 6 delimiting such a housing 11 have a U-shaped cross section comprising a vertical wall and two horizontal flanges at the upper and lower ends of the vertical wall. The two crossmembers 6 delimiting the housing 11 are positioned parallel to one another and in such a way that the horizontal flanges face toward the inside of the housing 11.

A sensor 13 is placed in each housing 11. The sensor 13 is of substantially cylindrical shape. In an alternative form, the sensor is of rectangular shape. The sensor 13 comprises a lower part and an upper part, weight being measured by measuring the strain or the relative movement between these two parts.

The upper part of the sensor 13 rests on a plate 14 which bears against the upper horizontal flanges of two crossmembers 6 delimiting the housing 11.

The lower part of the sensor 13 is secured to a mounting plate 15 which is lashed to the support by lashing-down means arranged under the housing 11 and including screws 16 collaborating with a hole formed in the horizontal flange of a crossmember 6 delimiting the housing 11 of the sensor 13. The lashing-down means are intended to secure the sensor 13 to the support while an element 1 is being transported from the workshop to the installation site so as to avoid any degradation of its function and maintain the calibration achieved.

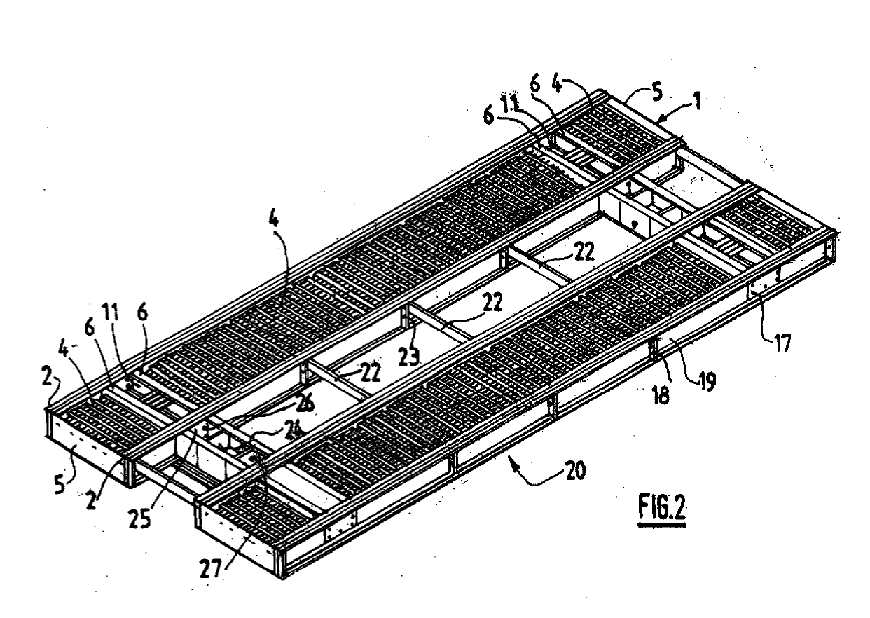

Each of the elements 1 illustrated in FIG. 2 comprises at least two sensors 13. The two sensors 13 of each element 1 are positioned aligned in the longitudinal direction of the support.

Each element 1 comprises attachment means on the surface of the vertical wall of each side rail 2 that faces toward the outside of the support. The side rails 2 comprise fixing holes 17 for screws. These holes are created in the vertical wall of the side rails 2, so that they open onto the exterior surface thereof. These fixing holes 17 constitute first means of attachment, these first means of attachment being positioned facing the housings 11 of the sensors 13.

The support also comprises vertical partitions 18 created on the outside of the side rails 2 and comprised between the horizontal flanges of the side rails 2, each partition 18 being perpendicular to the vertical wall of the side rails 2.

Formed in the vertical partitions 18 are fixing holes 19 that constitute second means of attachment 19.

As depicted in FIG. 2, a weighbridge module 20 intended to form a portion of this weighbridge, the width of which is that of the weighbridge, comprises two elements 1 positioned parallel to one another. The two elements 1 are connected by rigid connecting means.

These connecting means comprise spacer pieces 22 attached to the vertical partitions 18 on the elements 1. Each spacer piece 22 is in the form of a profiled bar of rectangular shape, the upper edge of which is in contact at its two ends with the upper horizontal flanges of the side rails 2, and which has an opening 23 into which an attachment screw can be inserted for attachment to a fixing opening 19 of a vertical partition 18.

The rigid connecting means also comprise connecting structures 24 intended to collaborate with the first means of attachment 17 of the elements 1.

These connecting structures 24 comprise two U-shaped lateral crossmembers forming two vertical walls and horizontal flanges, these two crossmembers being secured to two attachment plates 25 intended to be held firmly against the vertical walls of the side rails 2 at fixing holes 17 in these vertical walls, for screw fastening, the attachment plates 25 comprising fixing openings 26 intended to be positioned facing the fixing holes 17 in the side rails 2 that constitute the first means of attachment 17.

The connecting structures 24 comprise reinforcing partitions 27 perpendicular to the crossmembers and collaborating therewith.

It should be noted that the connecting structures 24 are positioned facing the sensors 13 situated in the housings 11 for sensors 13 of the elements 1.

The presence of the connecting structures 24 ensures the rigidity of the structure at the portions comprising the sensors 13.

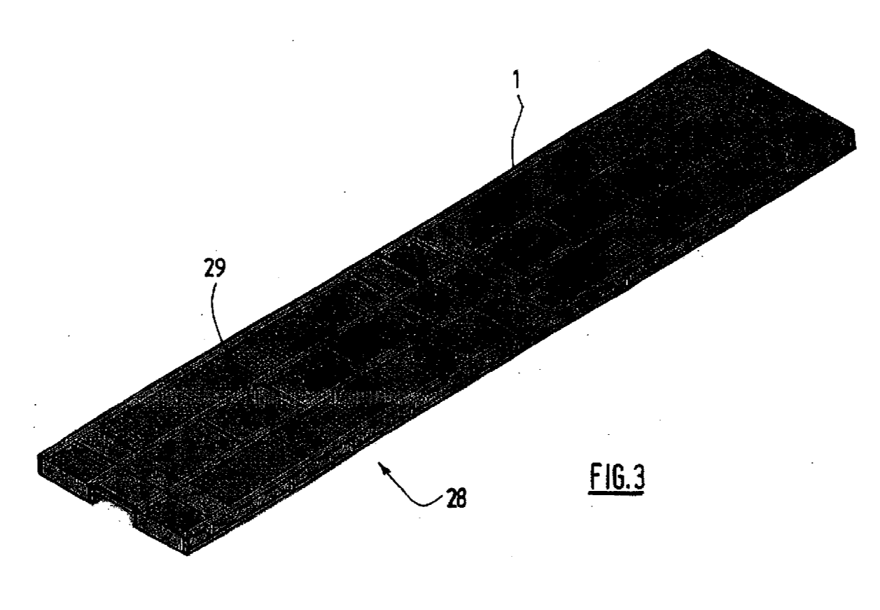

As depicted in FIG. 3, a weighbridge 28 according to the invention is obtained by assembling one or more modules 20 as described hereinabove.

Cover plates 29 may be positioned between the elements 1, above the connecting structures 24 and the spacer pieces 22 resting on the edge of the elements 1 or on the connecting means 22, 24, to complete the upper surface of the support.

A weighbridge 28, using the elements 1 described hereinabove, is created and calibrated as follows.

First of all, a weighbridge 28 module 20 comprising two elements 1 and four sensors 13 and connecting structures 22, 24 is assembled. When a weighbridge is made up of several elements 20, these elements 20 are positioned one after the other.

The entire statically determinate structure thus formed is calibrated using calibrating weights.

The mounting plates 15 of the sensors 13 are lashed down against the elements 1 then the connecting structures 22, 24 are dismantled.

The elements 1 can then be transported to the site on which the weighbridge 28 is to be installed, using conventional means of transport, the width of the elements 1 being less than that of the weighbridge 28.

Once the elements 1 have been conveyed to the installation site, the elements 1 are set down on an appropriate support then assembled with the connecting structures 24 and the spacer pieces 22, then concrete can be poured into those parts of the elements that form formwork 4.

To transport the elements 1 from the workshop to the installation site, the mounting plate 15 is lashed down onto the housing 11. Holes are provided for this in the horizontal flange and in the mounting plate 15. The holes in the mounting plate 15 are, for example, tapped, and those in the horizontal flange are plain.

Once the elements 1 that can be used to create a weighbridge 24 are in place, the sensors 13 and, in particular, the mounting plates 15, are unleashed.

As can be seen from the foregoing description, there is no dismantling of the sensors 13 between the site of manufacture and the site of installation on which the weighbridge 28 is mounted. The standards covering weighbridges 28 therefore allow the weighbridge 28 to undergo just one test, as is the case of transportable weighbridges. This test can be carried out at the factory, thus limiting costs. Indeed, there is then no need to move calibration weights around.

The elongate support is intended to form a lateral part of the modules 20/weighbridge 28 against which one or more wheel(s) of the vehicle or of the rolling stock rests or rest as this vehicle or rolling stock passes over the weighbridge.

Although the invention has been described in conjunction with some particular embodiments, it is quite obvious that it is not in any way restricted thereto and that it comprises all technical equivalents of the means described and combinations thereof where these fall within the scope of the invention.

1. An element for a weighbridge or a weighbridge module, intended in particular for weighing automotive vehicles or rolling stock, comprising:
an elongate support intended to form a lateral part of an upper surface of the weighbridge on which one or more wheel of the vehicle or of the rolling stock rests as the vehicle or rolling stock crosses the weighbridge,
at least two sensors positioned aligned in a longitudinal direction of the support and attached under the support,
means of attachment intended to attach the weighing element to another weighing element of the same type,
means of lashing down the weighing sensors when the element is being transported.

2. The element as claimed in claim 1, wherein the attachment means are designed to attach means of rigid connection between the elements.

3. The element as claimed in claim 1, wherein the support comprises at least one part that forms formwork for casting concrete.

4. The element as claimed in claim 1, wherein the support comprises at least two longitudinal side rails connected laterally by a plurality of transverse crossmembers.

5. The element as claimed in claim 4, wherein the sensors are housed in a housing formed between two crossmembers.

6. The element as claimed in claim 4, wherein at least one formwork-forming part is laterally delimited by the two side rails and longitudinally delimited by two end crossmembers, the bottom of the formwork comprising interjoists held in place by intermediate crossmembers shorter in height than end crossmembers.

7. The element as claimed in claim 6, wherein the formwork-forming part comprises a reinforcement of metal rods resting on the side rails and/or the end crossmembers.

8. The element as claimed in claim 5, wherein an upper part of the sensor bears against a plate that bears against upper horizontal flanges of two crossmembers delimiting the housing.

9. The element as claimed in claim 1, wherein the lashing-down means comprise means of screwing a mounting plate comprising a bottom part of the sensor to part of the support.

10. The element as claimed in claim 9, in which the screwing means are screwed to at least one crossmember delimiting the housing of the sensor.

11. A weighbridge or weighbridge module, intended in particular for weighing automotive vehicles or rolling stock, comprising:
two elements as claimed in claim 1, and
means of rigid connection attached between the weighing elements.
